(19) United States
(12) Patent Application Publication
(10) Pub. No.: US 2015/0296314 A1
(43) Pub. Date: Oct. 15, 2015

(54) RECEIVER/LOUDSPEAKER

(71) Applicant: GN ReSound A/S, Ballerup (DK)

(72) Inventors: Henrik NIELSEN, Roskilde (DK); Jan JOHANSEN, Koge (DK)

(73) Assignee: GN ReSound A/S, Ballerup (DK)

(21) Appl. No.: 14/333,397

(22) Filed: Jul. 16, 2014

(30) Foreign Application Priority Data
Apr. 10, 2014 (DK) PA 2014 70201
Apr. 10, 2014 (EP) 14164146.4

(51) Int. Cl. H04R 25/00

(52) U.S. Cl. CPC H04R 25/654; H04R 25/60; H04R 2225/025; H04R 2460/11

(57) ABSTRACT

A hearing aid includes: a hearing aid housing; a receiver with a receiver housing, wherein the hearing aid housing comprises an internal cavity configured for containing the receiver; and an adapter having first mounting surfaces configured for holding the receiver, and second mounting surfaces configured for releasably attaching the adapter to a part of the hearing aid housing.

### RELATED APPLICATION DATA

This application claims priority to, and the benefit of, Danish Patent Application No. PA 2014 70201, filed on Apr. 10, 2014, pending, and European Patent Application No. 14164146.4, filed on Apr. 10, 2014, pending. The entire disclosures of the above applications are expressly incorporated by reference herein.

### FIELD

The present disclosure relates to a hearing aid with a housing and a receiver/loudspeaker with a receiver housing, and where the housing comprises an internal cavity adapted for containing the receiver/loudspeaker.

### BACKGROUND

Hearing aids of the above mentioned kind are known in a lot of different embodiments, where the housing comprises a socket for mounting the receiver directly in the housing.

Especially in relation to ITE “In The Ear” hearing aids there is an ongoing re-search and development with respect to provide ITE hearing aids with optimal sound quality and performance on one hand, and on the other hand providing a hearing aid being as discrete as possible in the ear of the user. This requires that the components of the hearing aid, such as e.g. the receiver, the filter and its socket, and the electronics may be selected or combined to suit individual needs, and at the same time providing good sound quality.

### SUMMARY

It is an object to provide a hearing aid providing the freedom of combining different active components such as receivers, signal processors or filters without the need of having a housing adapted for each combination.

This is obtained with the hearing aid mentioned in the introduction and wherein the hearing aid comprises an adapter having first mounting surfaces adapted for holding the receiver/loudspeaker, and second mounting surfaces adapted for releasably attaching the adapter to the housing.

Thereby a single housing is needed for all combinations because a separate adapter can be adapted for each receiver design.

In a preferred embodiment the housing comprises a first housing part made from a relatively rigid material, and a second housing part made from a relatively resilient material, and where the second housing part is adapted for holding the receiver/loudspeaker.

Thereby it is possible to design the housing so that the second housing part constitutes the innermost housing part in the ear channel of a user, and so that the hearing aid is able to be deformed when the users ear channel is deformed e.g. when the user turns his head or moves his jaw.

In this relation the second housing part may preferably comprise a filter socket adapted for mounting a filter, such as a cerumen filter, in the second housing part.

Furthermore the second housing part may advantageously comprise an internal cavity adapted for containing the receiver/loudspeaker.

In this relation the second housing part may preferably comprise a mounting passage adapted for insertion of the receiver into the internal cavity, and where the mounting passage has a cross section being smaller than the smallest cross section of the receiver, so that the receiver can be mounted in the internal cavity through the passage only by elastically deforming the second housing.

The rigid housing part may also comprise an internal cavity containing a signal processor adapted for providing an audio signal to the receiver/loudspeaker, via a set of electrical wires extending from the signal processor and to the receiver.

In this relation the mounting passage may preferably extend between the internal cavity in the first housing part, and the internal cavity in the second housing part.

Furthermore the electrical wires may preferably extend through the mounting passage.

In a further preferred embodiment, the length of the electrical wires are so long that the second housing part can be detached and removed a distance away from the first housing part, without the need of dismantling or stretching the electrical wires.

A hearing aid includes: a hearing aid housing; a receiver with a receiver housing, wherein the hearing aid housing comprises an internal cavity configured for containing the receiver; and an adapter having first mounting surfaces configured for holding the receiver, and second mounting surfaces configured for releasably attaching the adapter to a part of the hearing aid housing.

Optionally, the second mounting surfaces of the adapter are configured for releasably attaching the adapter to an inner wall of the internal cavity of the hearing aid housing.

Optionally, the hearing aid housing comprises a first housing part and a second housing part, the second housing part being the adapter, and wherein the first housing part is made from a first material, and the second housing part is made from a second material, the first material being more rigid than the second material.

Optionally, the second housing part is configured for placement further into an ear channel of an ear of a user than the first housing part when the hearing aid is inserted into the ear.

Optionally, the second housing part comprises a filter socket configured for mounting a filter

Optionally, the filter comprises a cerumen filter.

Optionally, the second housing part comprises the internal cavity for containing the receiver.

Optionally, the second housing part comprises a passage leading to the internal cavity that contains the receiver, and wherein the passage has a cross-section being smaller than the smallest cross section of the receiver.

Optionally, the second housing part allows the receiver to be mounted in the internal cavity through the passage by elastic deformation.

Optionally, the first housing part comprises a first internal cavity containing a signal processor configured for providing an audio signal to the receiver via a set of electrical wires extending from the signal processor and to the receiver.

Optionally, the hearing aid further includes a passage extending between the first internal cavity in the first housing part, and a second internal cavity in the second housing part, the second internal cavity comprising the internal cavity for containing the receiver.

Optionally, the electrical wires extends through the passage.

Optionally, the second housing part is detachably coupled to the first housing part.

Optionally, a length of the electrical wires permits detachment and removal of the second housing part by a distance from the first housing part, the distance being long enough to allow access to mounting points of the electrical wires without a need of dismantling or stretching the electrical wires.

Other and further aspects and features will be evident from reading the following detailed description of the embodiments.

### BRIEF DESCRIPTION OF THE DRAWINGS

In the following, the embodiments will be described in greater detail with reference to the enclosed figures. It should be emphasized that the embodiments shown are used for example purposes only and should not be used to limit the scope of the claimed invention.

FIG. 1: Is a principle drawing showing a cross section of a hearing aid according to some embodiments,

FIG. 2: Is a principle drawing showing the opposite cross section of the hearing aid shown in FIG. 1,

FIG. 3: Is a front view of the hearing aid according to FIGS. 1 and 2 seen from one side,

FIG. 4: Is a principle drawing showing a cross section of an alternative embodiment of a hearing aid,

FIG. 5: Is a principle drawing showing an enlarged detail of one embodiment of an adapter/receiver assembly,

FIG. 6: Is a perspective view of the adapter/receiver shown in FIG. 5,

FIG. 7: Is a principle drawing showing an enlarged detail of an alternative embodiment of an adapter/receiver assembly, and

FIG. 8: Is a perspective view of the adapter/receiver shown in FIG. 7.

### DETAILED DESCRIPTION OF THE EMBODIMENTS

It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

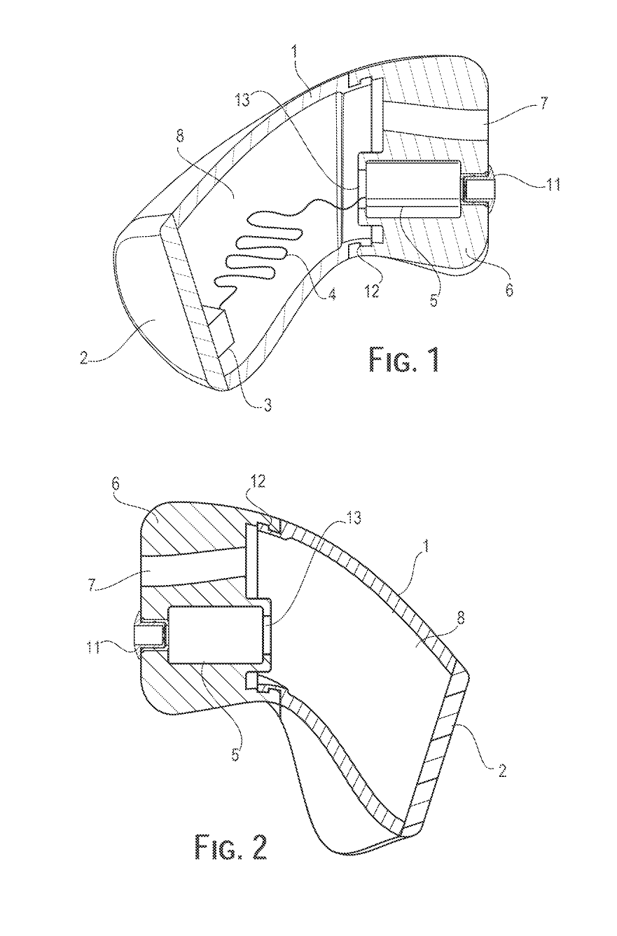

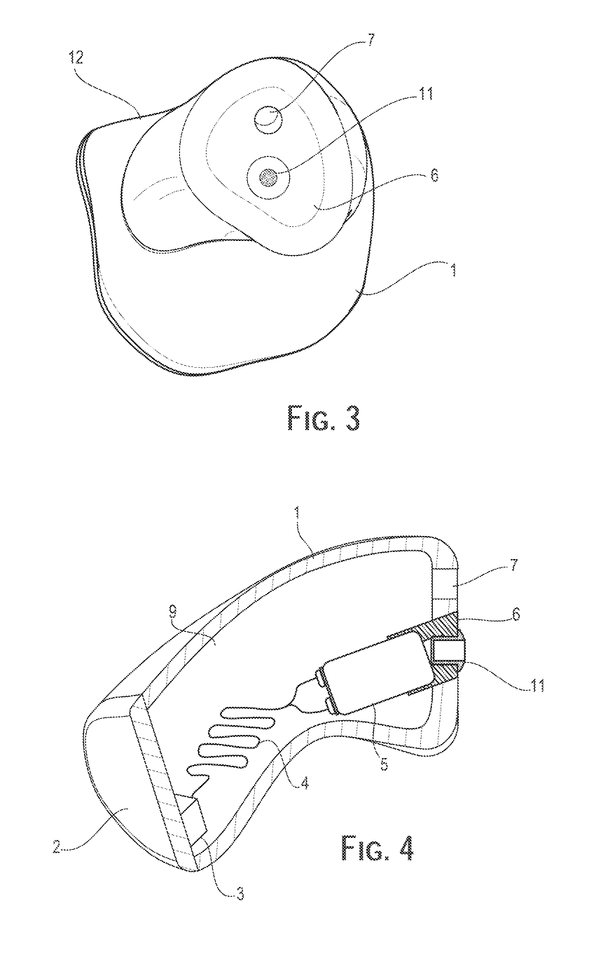

FIGS. 1, 2 and 4 are principle drawings showing a cross section through hearing aids according to different embodiments, and FIG. 3 shows a front view of the embodiment shown in FIGS. 1 and 2 seen from the end that extends farthest into the ear of the user during use, These hearing aids are both of the ITE (in the ear) type being adapted for being positioned completely in the ear of the user, but it will be apparent to the skilled person that one or more features described herein will also be applicable to other types of hearing aids being only partly positioned in the ear of the user.

The hearing aids shown in FIGS. 1 and 4 has a hearing aid housing 1 being closed at one end by a face plate 2, which will normally be the only visible part of the hearing aid, when the hearing aid is positioned in the ear of the user. Thereby the hearing aid housing 1 and the face plate 2 encloses an internal cavity 8 providing space for mounting different functional devices.

In hearing aids of the ITE type all such functional devices, e.g. electronics 3, batteries (not shown), wiring 4, a microphone (not shown), a receiver 5 and an adapter 6 necessary for the function of the hearing aid have to be positioned in the narrow space provided by the internal cavity 8 in the hearing aid housing 1, and therefore it is important to have a high degree of freedom with respect to positioning each device in an optimal position in order to be optimally utilize the space in the hearing aid housing 1.

As it is apparent to the skilled person what functional devices are necessary or nice to have in an ITE hearing aid, then only the electronics 3, the wiring 4, a cerumen filter 11 and the receiver 5 are shown in FIGS. 1 and 4.

Normally the hearing aid housing 1 further comprises e.g. a pressure equalizing channel 7 extending from the internal cavity 8 and to the outer surface on the hearing aid housing 1. This pressure equalizing channel 7 must be arranged so that it is possible, e.g. via a tube extending from the pressure equalizing channel 7 and to a corresponding opening in the face plate 2 (not shown), to equalize pressure differences between the environment and the closed space in the ear of the user carrying the hearing aid, and thereby further reducing the freedom to position the functional devices in the internal cavity 8 of the hearing aid housing 1.

According to some embodiments, an adapter 6 is mounted to the hearing aid housing 1, and furthermore the cerumen filter 11 is arranged in the adapter 6 in the end of the hearing aid housing 1 facing the inside of the ear of the user.

The adapter 6 is in the embodiment shown in FIGS. 1, 2 and 3 forms a part of the hearing aid housing 1 constituting the front end of the hearing aid that extends farthest into the ear of the user during use. This adapter 6 is mounted on the hearing aid housing 1 by means of a snap connection 12, and is made from a material being more resilient that the material from which the rear end of the hearing aid housing 1 is made from. Thereby, due to the flexibility of the adapter 6, a more comfortable fit in the user ear is provided, allowing the front end of the hearing aid to adapt to the individual shape of the users ear as well as the deformations of the auditory meatus that occurs e.g. when the user chews or moves his head. Furthermore the flexible adapter 6 shown in FIGS. 1, 2, and 3 provides a flexible support for the receiver 5 and/or the filter 11, so that when the adapter 6 is deformed, then the receiver 5 and the filter 11 follows the deformation without significant resistance.

As the adapter 6 shown in FIGS. 1, 2 and 3 almost completely encloses the receiver 5, then this adapter minimizes the risk that other devices in the internal cavity 8 touches the receiver 5 and thereby adversely affects the quality of the sound provided by the hearing aid. In this embodiment, however, a mounting passage 13 for inserting the receiver 5 in the adapter 6 is provided allowing the wiring 4 to extend through the mounting passage 13.

In the alternative embodiment shown in FIGS. 4, 5, 6, 7 and 8 the adapter 6 may be made from a resilient material or from the same material as the rear housing part 1, e.g. by injection moulding, where after the adapter 6 is mounted to an internal wall 14 of the internal cavity 8 of the hearing aid housing 1 by means of a friction fit as shown in the figures, or by a snap fit or by gluing, e.g. by using heat releasable glue.

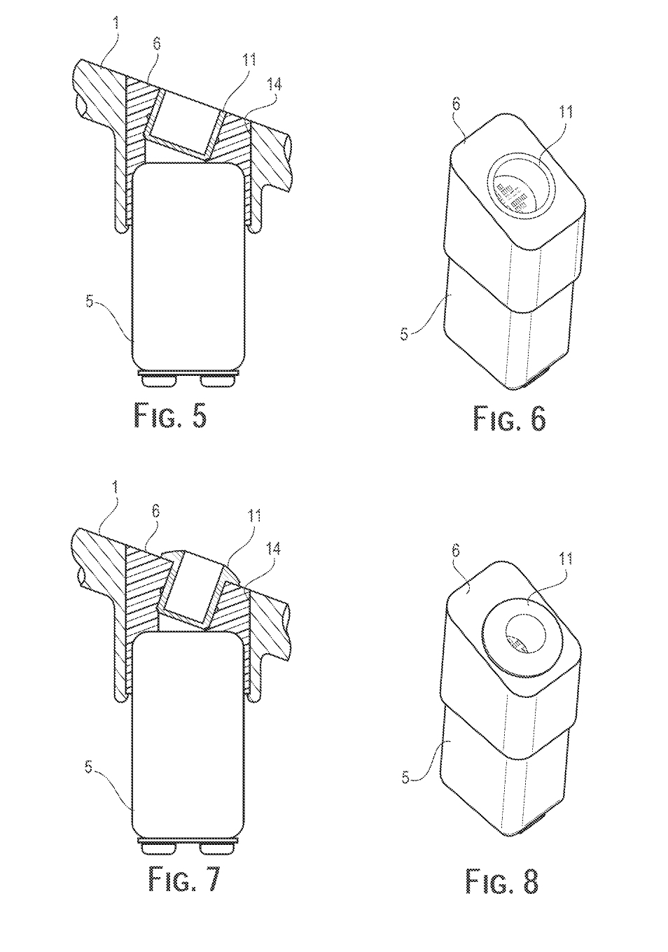

According to these embodiments, the adapter 6 is adapted for holding the receiver 5 as well as for insertion and detachment of a filter unit 11, such as a cerumen filter. The use of a separate adapter 6 according to some embodiments thereby provides the option of e.g. using the same hearing aid housing 1 as well as he same functional devices (3, 4) arranged in the hearing aid housing 1 with different adapters 6 designed for holding different receivers 5 or different cerumen filters 11, such as it is shown in FIGS. 5 to 8, where FIGS. 5 and 6 shows a first design of an adapter 6, providing the option of mounting a first type of cerumen filter 11 and FIGS. 7 and 8 shows a second and different design of an adapter 6, providing the option of mounting a second type of cerumen filter 11.

In the same manner it will be apparent to the skilled person that there may be different adapters 6 for holding different receivers 5, and thereby it is possible with relatively few standard components to provide custom designed hearing aids for different users requiring different kinds of cerumen filters 11 and/or receivers 5.

Although some embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention. As an example of this it will be apparent to the skilled person that the invention may also be used in relation to hearing aids of another type than the above mentioned ITE type, even though the advantages provided by the invention is especially relevant to the ITE type hearing aids.

In device claims enumerating several features, several of these features can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

The following items are in accordance with one or more embodiments described herein:

Item 1. A hearing aid with a hearing aid housing and a receiver with a receiver housing, the hearing aid housing comprising an internal cavity adapted for containing the receiver, wherein the hearing aid comprises an adapter having first mounting surfaces adapted for holding the receiver, and second mounting surfaces adapted for releasably attaching the adapter to the hearing aid housing.

Item 2. The hearing aid according to item 1, wherein the second mounting surfaces on the adapter are adapted for releasably attaching the adapter to an inner wall of the internal cavity of the hearing aid housing.

Item 3. The hearing aid according to item 1, wherein the hearing aid housing comprises a first housing part made from a relatively rigid material and a second housing part forming the adapter, and being made from a relatively resilient material, and where the first housing part and the second housing part are adapted for mutual fixation, and the second housing part is adapted for holding the receiver.

Item 4. The hearing aid according to item 3, wherein the second housing part constitutes the part of the housing that extends farthest into a user's ear channel when the hearing aid is inserted into the ear.

Item 5. The hearing aid according to item 3, wherein the second housing part comprises a filter socket adapted for mounting a filter, such as a cerumen filter, in the second housing part.

Item 6. The hearing aid according to item 3, 4 or 5, wherein the second housing part comprises the internal cavity adapted for containing the receiver.

Item 7. The hearing aid according to item 6, wherein the second housing part comprises a mounting passage to the internal cavity, and where the mounting passage has a cross-section being smaller than the smallest cross section of the receiver, allowing the receiver to be mounted in the internal cavity through the passage by elastically deforming the second housing.

Item 8. The hearing aid according to one or more of the items 3, 4, 5, 6 or 7, wherein the first housing part comprises an internal cavity containing a signal processor adapted for providing an audio signal to the receiver via a set of electrical wires extending from the signal processor and to the receiver.

Item 9. The hearing aid according to item 7 and 8, wherein the mounting passage extends between the internal cavity in the first housing part, and the internal cavity in the second housing part.

Item 10. The hearing aid according to item 9, wherein the electrical wires extends through the mounting passage.

Item 11. The hearing aid according to item 8, wherein the length of the electrical wires permits detachment and removal of the second housing part by a distance from the first housing part, the distance being long enough to allow access to the mounting points of the electrical wires without the need of dismantling or stretching the electrical wires.

Although particular embodiments have been shown and described, it will be understood that they are not intended to limit the claimed inventions, and it will be obvious to those skilled in the art that various changes and modifications may be made without departing from the spirit and scope of the claimed inventions. The specification and drawings are, accordingly, to be regarded in an illustrative rather than restrictive sense. The claimed inventions are intended to cover alternatives, modifications, and equivalents, as defined by the claims.

1. A hearing aid comprising:
a hearing aid housing;
a receiver with a receiver housing, wherein the hearing aid housing comprises an internal cavity configured for containing the receiver; and
an adapter having first mounting surfaces configured for holding the receiver, and second mounting surfaces configured for releasably attaching the adapter to a part of the hearing aid housing.

2. The hearing aid according to claim 1, wherein the second mounting surfaces of the adapter are configured for releasably attaching the adapter to an inner wall of the internal cavity of the hearing aid housing.

3. The hearing aid according to claim 1, wherein the hearing aid housing comprises a first housing part and a second housing part, the second housing part being the adapter, and wherein the first housing part is made from a first material, and the second housing part is made from a second material, the first material being more rigid than the second material.

4. The hearing aid according to claim 3, wherein the second housing part is configured for placement further into an ear channel of an ear of a user than the first housing part when the hearing aid is inserted into the ear.

5. The hearing aid according to claim 3, wherein the second housing part comprises a filter socket configured for mounting a filter.

6. The hearing aid according to claim 5, wherein the filter comprises a cerumen filter.

7. The hearing aid according to claim 3, wherein the second housing part comprises the internal cavity for containing the receiver.

8. The hearing aid according to claim 7, wherein the second housing part comprises a passage leading to the internal cavity that contains the receiver, and wherein the passage has a cross-section being smaller than the smallest cross section of the receiver.

9. The hearing aid according to claim 8, wherein the second housing part allows the receiver to be mounted in the internal cavity through the passage by elastic deformation.

10. The hearing aid according to claim 3, wherein the first housing part comprises a first internal cavity containing a signal processor configured for providing an audio signal to the receiver via a set of electrical wires extending from the signal processor and to the receiver.

11. The hearing aid according to claim 10, further comprising a passage extending between the first internal cavity in the first housing part, and a second internal cavity in the second housing part, the second internal cavity comprising the internal cavity for containing the receiver.

12. The hearing aid according to claim 11, wherein the electrical wires extends through the passage.

13. The hearing aid according to claim 10, wherein the second housing part is detachably coupled to the first housing part.

14. The hearing aid according to claim 13, wherein a length of the electrical wires permits detachment and removal of the second housing part by a distance from the first housing part, the distance being long enough to allow access to mounting points of the electrical wires without a need of dismantling or stretching the electrical wires.
